(19) United States
(12) Patent Application Publication
(10) Pub. No.: US 2026/0170530 A1
(43) Pub. Date: Jun. 18, 2026

(54) SALES PROMOTION CIRCULATION METHOD, PROGRAM, AND SYSTEM

(71) Applicants: Toshiyuki MURAMATSU, Shizuoka (JP); Yuki TAKEUCHI, Fukuoka (JP)

(72) Inventors: Toshiyuki MURAMATSU, Shizuoka (JP); Yuki TAKEUCHI, Fukuoka (JP)

(21) Appl. No.: 19/126,995

(22) PCT Filed: Aug. 7, 2023
(86) PCT No.: PCT/JP2023/028808

§ 371 Date: May 2, 2025

(30) Foreign Application Priority Data
Nov. 4, 2022 (JP) 2022-177727
Mar. 21, 2023 (JP) 2023-044839
May 11, 2023 (JP) 2023-078270

(51) Int. Cl. G06Q 30/0226; G06Q 30/0207

(52) U.S. Cl. CPC G06Q 30/0233; G06Q 30/0224

(57) ABSTRACT

A sales promotion circulation method implemented by a computer, the sales promotion circulation method including: a benefit issuing step of issuing, to a user, benefit data whose “benefit quantity” and “issuer ID” are managed; a benefit conversion step of performing, for use of the benefit data by the user, conversion related to the redeemed benefit quantity between a payee of the benefit data and the issuer; and a reward circulation step of performing reception processing of receiving a success reward for sales promotion (hereinafter referred to as “sales promotion reward”) by the benefit data from the payee of the benefit data, and providing either a part or all of the sales promotion reward to the issuer.

### TECHNICAL FIELD

The present invention relates to a sales promotion circulation method, a sales promotion circulation program, and a sales promotion circulation system.

### BACKGROUND ART

Conventionally, benefit services for granting points to purchasers according to the cost of products or services purchased have been known.

In addition, conventionally, benefit services have been known that give coupons (corresponding to gift certificates, discount tickets, complimentary tickets, or the like) to consumers for free through a campaign, an application of a mobile terminal, or the like.

The consumer can redeem a benefit such as collected points or a coupon for the cost of a product or service newly purchased.

In addition, it is known that distributors offer services such as their own points or coupons that can be used only within their company or group in order to promote sales by binding the customers to them.

Further, Patent Literature 1 discloses a business model that “allows benefits to be used mutually across different business operators by transferring issued points from one business operator to another based on transfer conditions (for example, conversion rate)”.
The prior arts (the seven references in section 8-5-1 of the application request) listed in the “Declaration as to non-prejudicial disclosures or exceptions to lack of novelty” were published by the applicant himself/herself on the Internet before the priority date. These prior arts (the seven references in section 8-5-1 of the application request) correspond to the contents of claims 1, 2, 11, and 12 at the time of filing of the international application. Therefore, in “designated states in which exceptions to lack of novelty is not applied”, the prior arts set force (the seven references in section 8-5-1 of the application request) may form a document X with respect to claims 1, 2, 11, and 12 at the time of filing of the international application.

### CITATION LIST

### Patent Literature

Patent Literature 1: JP 2010-262566 A

### SUMMARY OF INVENTION

### Technical Problem

In the technique of Patent Literature 1, individually issued points can be mutually used across different business operators. Therefore, there is an advantage that the degree of freedom of point use increases on the user side.

However, due to the following reasons, it cannot be said that this technique provides sufficient business advantages on the business operator side issuing the points.

First, if the degree of freedom of a benefit such as points or coupons is increased, the party offering the benefit cannot bind the customers to them.

In addition, even if a business operator pays a burden to issue a benefit, the customers may use the benefit for another business operator. In that case, one business operator pays a burden of a benefit for the other business operator, which may impair business fairness.

Note that Patent Literature 1 does not sufficiently disclose the above-described problems, nor does it describe or suggest a technical means for solving the problem.

Therefore, in order to solve at least one of the above-described problems, an object of the present invention is to provide a technical means capable of enhancing fairness between business operators while enabling mutual use of benefits across different business operators.

### Solution to Problem

The present invention is a sales promotion circulation method implemented by a computer system, and includes the following steps.

A benefit issuing step performs issuance processing of issuing, to a user, benefit data whose “benefit quantity that can be redeemed toward a payment made by the user” and “issuer ID unique to an issuer of the benefit quantity” are managed.

A benefit conversion step performs, for use of the benefit data by the user, conversion processing related to the redeemed benefit quantity between a payee of the benefit data and the issuer indicated by the issuer ID of the benefit data.

A reward circulation step performs reception processing of receiving a success reward for sales promotion (hereinafter referred to as “sales promotion reward”) by the benefit data from the payee of the benefit data, and performing transfer processing of providing either a part or all of the sales promotion reward to the issuer indicated by the issuer ID of the used benefit data.

### Advantageous Effects of Invention

According to the sales promotion circulation technique of the present invention, a part or all of a sales promotion reward is provided from a business operator of the payee of the benefit data to a business operator of the issuer of the benefit data.

As the exchange of sales promotion rewards continues, sales promotion rewards circulate between the business operators. As a result, it is possible to technically improve the fairness on the business operator side by the circulation of sales promotion rewards while enhancing user convenience enabling mutual use of the benefit data across different business operators.

Note that details of problems, configurations, and effects other than those described above will be described in the embodiments described later.

### BRIEF DESCRIPTION OF DRAWINGS

FIG. 1 is a block diagram illustrating an overall configuration of Example 1.

FIG. 2 is a diagram illustrating a data configuration of a database 140.

FIG. 3 is a flowchart illustrating an operation of issuing a benefit in a sales promotion circulation method.

FIG. 4 is (the first part of) a flowchart illustrating the operation of benefit conversion and sales promotion circulation in the sales promotion circulation method.

FIG. 5 is (the second part of) a flowchart illustrating the operation of benefit conversion and sales promotion circulation in the sales promotion circulation method.

FIG. 6 is a block diagram illustrating an overall configuration of Example 2.

FIG. 7 is a flowchart illustrating return processing of a retained amount in Example 3.

FIG. 8 is a flowchart illustrating reprocurement processing of the retained amount in Example 3.

### DESCRIPTION OF EMBODIMENTS

Hereinafter, examples of the present invention will be described with reference to the drawings.

Note that, in the description here, in order to clarify the entity performing each operation, an operation corresponding to “###step” in the claims will be described as an operation performed by “###unit”.

### Example 1

### <<Overall Configuration of Example 1>>

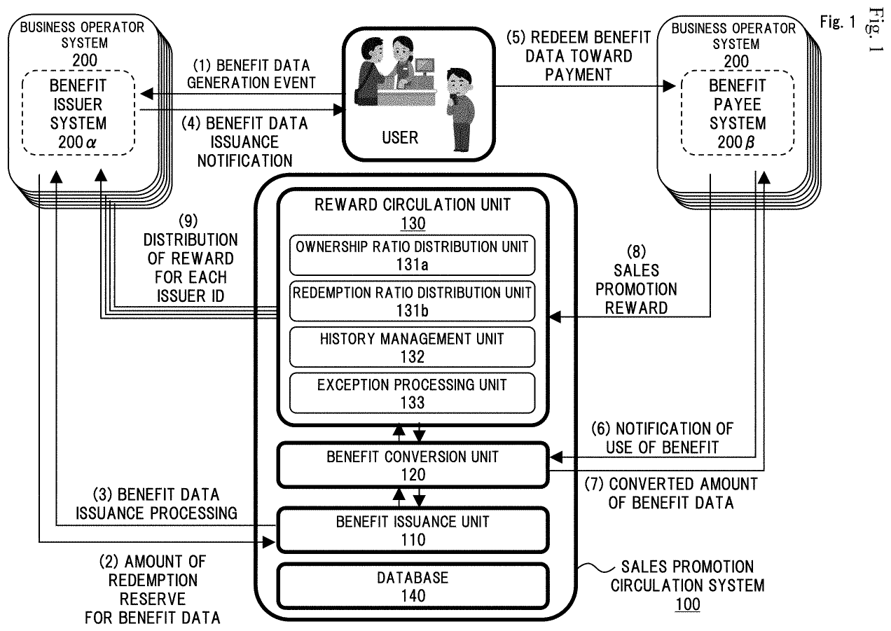

FIG. 1 is a block diagram illustrating an overall configuration of Example 1.

The overall configuration of FIG. 1 is generally constituted by a sales promotion circulation system 100 and a business operator system 200, in addition to a user (customer).

The business operator system 200 is a system for sharing the issuance, conversion, and the like of benefit data (points, coupons, and the like) for the user on the business operator side. The business operator system 200 corresponds to, for example, a computer in a store (for example, point of sale system (POS)) of the business operator, an information terminal for a benefit service, a computer system used for electronic commerce (for example, online shopping) of the business operator, or the like. As another example, the business operator system 200 may be realized by executing an application on a terminal device (a smartphone, a tablet, a personal computer, or the like) owned by the user.

Note that, in order to make the following description easy to understand, a function related to the issuance of the benefit data in the business operator system 200 will be referred to as a benefit issuer system 200α, and a function related to the conversion of the benefit data will be referred to as a benefit payee system 200β.

On the other hand, the sales promotion circulation system 100 is communicably connected to the business operator system 200 via a communication line such as the Internet, and performs overall control of the benefit service.

The sales promotion circulation system 100 includes a benefit issuance unit 110, a benefit conversion unit 120, a reward circulation unit 130, and a database 140. The reward circulation unit 130 further includes an ownership ratio distribution unit 131a, a redemption ratio distribution unit 131b, a history management unit 132, and an exception processing unit 133.

Among these components, in a case where the user performs payment processing on the benefit issuer system 200α, the benefit issuance unit 110 issues, as benefit data, points to be returned to the user according to the payment by the user. This benefit data is benefit data in which “the benefit quantity corresponding to the point quantity” and “the issuer ID indicating the issuer of the benefit data” are managed. The benefit issuance unit 110 notifies (issues) the user of the issuance information for the generated benefit data, directly or via the benefit issuer system 200α.

In addition, the benefit issuance unit 110 issues a free coupon to the user as benefit data according to a campaign, an application, an advertisement, or the like of the business operator. This benefit data is benefit data in which “the benefit quantity corresponding to the coupon quantity” and “the issuer ID indicating the issuer of the benefit data” are managed. The benefit issuance unit 110 notifies (issues) the user of the issuance information for the generated benefit data, directly or via the benefit issuer system 200α.

In addition, in order to prepare for the future conversion of the benefit data, the benefit issuance unit 110 holds the amount of redemption reserve corresponding to the benefit quantity by collection processing or prepayment processing from the benefit issuer system 200α.

Note that the benefit issuer system 200α can set the benefit data to unique benefit data (benefit data with a limited range of use of the benefit data) for the benefit issuance unit 110. The benefit issuer system 200α can also set, for example, an issuance ratio of the normal benefit data and the unique benefit data to the benefit issuance unit 110.

In a case where the user redeems the benefit data toward the payment processing by the benefit payee system 200β, the benefit conversion unit 120 performs conversion processing of the benefit data by supplementing the benefit payee system 200β with an amount corresponding to the redeemed benefit quantity.

The reward circulation unit 130 performs reception processing in which a success reward for sales promotion (hereinafter referred to as “sales promotion reward”) by the benefit data is received from the benefit payee system 200β where the benefit data has been spent. Further, the reward circulation unit 130 performs transfer processing in which either a part or all of the sales promotion reward is paid to the benefit issuer system 200α indicated by the issuer ID of the used benefit data.

The database 140 holds data groups related to the benefit service. These data groups are data groups whose records and updates are managed by each unit of the sales promotion circulation system 100, and the contents thereof will be described later.

Note that the database 140 is not necessarily required for the sales promotion circulation system 100, and may be arranged in a localized or distributed manner on an external data server or cloud.

When a user uses the benefit data, the ownership ratio distribution unit 131a determines the ownership ratio of the benefit quantity owned by the user for each issuer. The ownership ratio distribution unit 131a performs processing of distributing sales promotion rewards to the issuers according to the determined ownership ratio.

Note that the ownership ratio distribution unit 131a excludes unique benefit data that cannot be used for the payee from the calculation of the ownership ratio when determining the ownership ratio for each issuer.

The redemption ratio distribution unit 131b determines a redemption ratio of benefit quantity for each issuer when the benefit data is redeemed and converted. The redemption ratio distribution unit 131b performs transfer processing in which sales promotion rewards are distributed to the issuers according to the determined redemption ratio.

When sales promotion rewards are to be distributed, the reward circulation unit 130 selectively uses the ownership ratio distribution unit 131a and the redemption ratio distribution unit 131b.

The history management unit 132 manages an ownership history of benefit data for each user.

The exception processing unit 133 refers to the ownership history managed by the history management unit 132 and obtains a history (hereinafter, referred to as “self-sales promotion history”) of the user's ownership of benefit data issued by the payee. The exception processing unit 133 estimates whether or not the user can be said to be a self-sales promotion customer of the payee based on this self-sales promotion history. When it is estimated that the user is a self-sales promotion customer, the exception processing unit 133 performs exception processing in which reception processing and transfer processing of sales promotion rewards are not performed.

### <<Data Configuration of Database 140>>

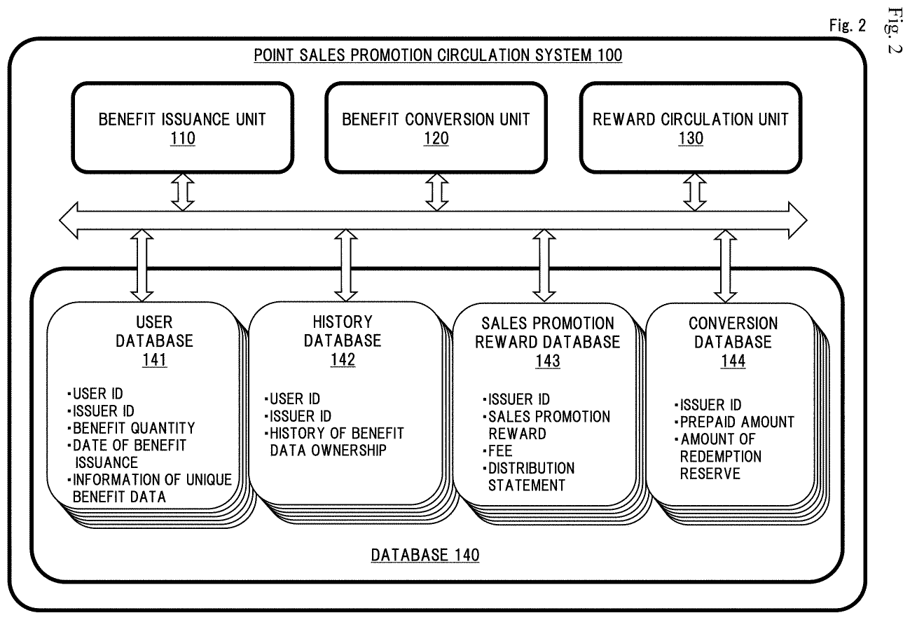

FIG. 2 is a diagram illustrating a data configuration of the database 140.

In the following, data groups used by the sales promotion circulation system 100 will be described with reference to FIG. 2. Note that, among the components illustrated in FIG. 2, the same components as those in FIG. 1 will not be described again here.

In FIG. 2, the database 140 includes a user database 141, a history database 142, a sales promotion reward database 143, and a conversion database 144.

Among them, the user database 141 holds a data group for managing the benefit data owned by a user. For example, this data group includes the following data.
User ID (ID information specific to user)
Issuer ID (ID information unique to a business operator that issues the benefit data)
Benefit quantity (the quantity redeemed toward payment, removed by conversion upon redemption)
Benefit issuance date (date and time of issuance of benefit data)
Information of unique benefit data (for example, information on the allowed range of use)

The history database 142 holds a data group related to the history of benefit data ownership. For example, this data group includes the following data.
User ID
Issuer ID
History of benefit data ownership (history data of benefit data owned by user)

The sales promotion reward database 143 holds a data group related to reception processing and transfer processing of sales promotion rewards. For example, this data group includes the following data.
Issuer ID
Sales promotion reward amount (reward amount received as sales promotion reward from benefit payee)
Fee (amount of fee paid to benefit issuer)
Distribution statement (distribution statement of sales promotion reward)

The conversion database 144 holds a data group related to balance processing at the time of issuing and conversion of benefit data. For example, this data group includes the following data.
Issuer ID
Prepaid amount (amount prepaid to prepare for future issuance of benefit from benefit issuer)
Amount of redemption reserve (amount received and held for future benefit conversion at the time of issuance of benefit data)

Note that the sales promotion circulation system 100 described above may be configured as a computer system including a central processing unit (CPU), a memory, and the like as hardware.

The hardware executes a “sales promotion circulation program” stored in a machine-readable storage medium to implement the respective functions of the sales promotion circulation system 100 described above, and each step of a sales promotion circulation method to be described later is executed by the computer system.

Some or all of such hardware may be replaced with a dedicated device, a machine learning machine, a digital signal processor (DSP), a field-programmable gate array (FPGA), a graphics processing unit (GPU), a programmable logic device (PLD), or the like.

In Addition, a cloud system may be configured by concentrating or distributing some or all of hardware and programs on a server on the cloud, so that the service of the “sales promotion circulation method” may be provided to each of a plurality of clients providing a benefit service.

### <<Benefit Issuance Processing>>

Next, an operation of issuing a benefit performed by Example 1 will be described.

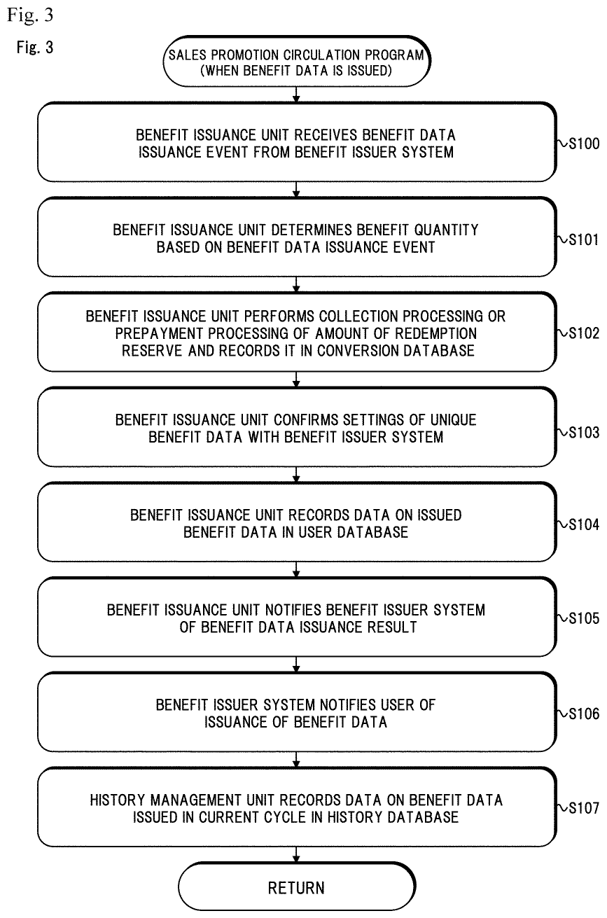

FIG. 3 is a flowchart for explaining an operation of issuing a benefit in the sales promotion circulation method.

Hereinafter, the steps will be described in order of the step numbers illustrated in FIG. 3.

Step S100: The user (customer) makes a payment for shopping or the like to the shop (business operator) providing the benefit service. Then, the payment information of the user (such as an issuer ID, a user ID, a payment amount, or a point benefit quantity) is transmitted from the benefit issuer system 200α of the business operator to the sales promotion circulation system 100. The benefit issuance unit 110 receives the payment information as a “benefit data issuance event”.

In addition, the user (customer) becomes a target of contribution or distribution of coupons through campaigns, applications, advertisements, a customer list, or the like of the store (business operator) providing the benefit service. Then, a coupon issuance request (the issuer ID, user ID, benefit quantity of a coupon, and the like) is transmitted from the benefit issuer system 200α of the business operator to the sales promotion circulation system 100. The benefit issuance unit 110 receives this coupon issuance request as a “benefit data issuance event”.

Note that the user (customer) or an external entity (including a country, a province, or the like) may request a benefit data issuance event for use by the user, for prepaid, for donation, for contribution, for transaction, for refund, or the like.

Step S101: The benefit issuance unit 110 determines the benefit quantity based on information on the benefit data issuance event. For example, the benefit issuance unit 110 determines the benefit quantity (corresponding to the points quantity) to be returned according to the payment made by the user based on the payment information. Furthermore, for example, the benefit issuance unit 110 determines the benefit quantity (corresponding to the coupon quantity) to be provided free of charge to the user based on the coupon issuance request.

Step S102: The benefit issuance unit 110 calculates the amount of redemption reserve (the cost required for future conversion of the benefit quantity). The benefit issuance unit 110 electronically receives the amount of redemption reserve from the benefit issuer system 200α. The benefit issuance unit 110 records the reception of the amount of redemption reserve in the conversion database 144. Note that the benefit issuer system 200α can also electronically pay in advance (prepay) a prepayment amount to the sales promotion circulation system 100. In that case, the benefit issuance unit 110 may accept the amount of redemption reserve by moving the corresponding amount from the prepaid amount to the amount of redemption reserve with respect to the conversion database 144.

Step S103: The benefit issuance unit 110 confirms the allowed range of use of the benefit data to be issued in this cycle with the benefit issuer system 200α as “information of unique benefit data”. The information of unique benefit data includes information such as whether or not the allowed range of use of the benefit data is limited to the issuer, its group company, or other specific range (range of purchased items or the like). Note that the benefit issuer system 200α can also determine the issuance ratio of the normal benefit data and the unique benefit data as “information of unique benefit data”.

Step S104: The benefit issuance unit 110 generates data (user ID, issuer ID, benefit quantity, date of issue of benefit, information of unique benefit data, and the like) of the benefit data to be issued based on the information obtained in steps S100 to S103, and records the data in the user database 141.

Step S105: The benefit issuance unit 110 notifies the benefit issuer system 200α of the issuance information of the benefit data recorded in step S104.

Step S106: The benefit issuer system 200α notifies the user of the issuance information of the benefit data via a “receipt”, an “application run on a mobile terminal owned by the user”, a “payment system such as a card used by the user”, or the like. Note that the benefit issuance unit 110 may directly notify the user of the issuance information of the benefit data using an email, an application, or the like.

Step S107: The history management unit 132 records the data of the benefit data that has been issued in this cycle in the history database 142 in order to add the data to the history of the user's ownership of the benefit data.

With the series of operations described above, the operation of benefit issuance in the sales promotion circulation method is completed.

### <<Conversion of Benefit Data and Sales Promotion Reward Processing>>

Next, the conversion of benefit data and the sales promotion reward processing of Example 1 will be described.

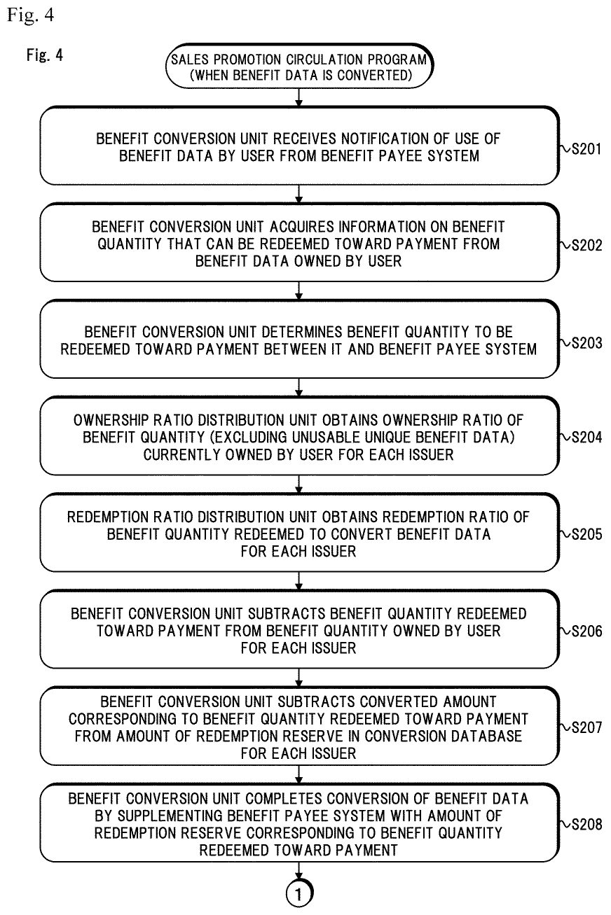

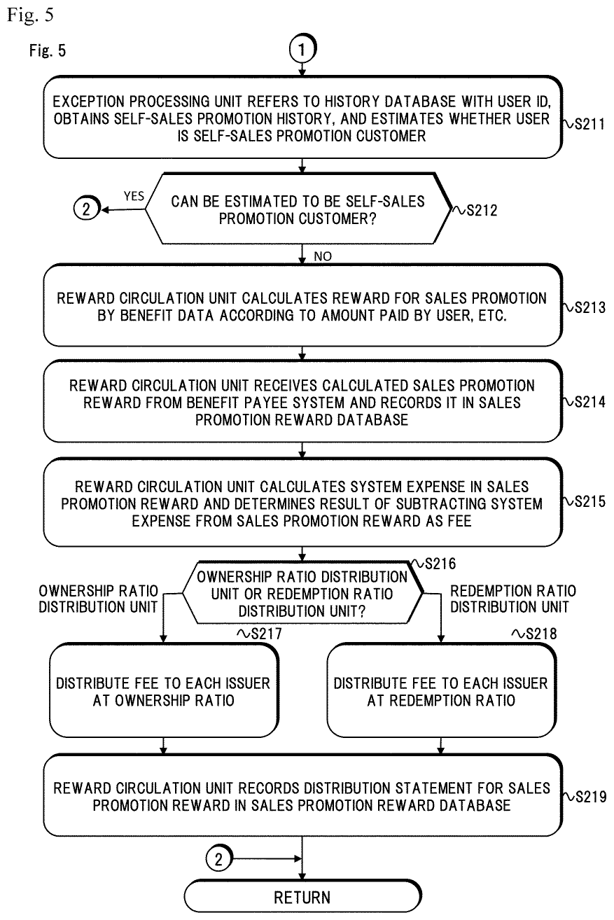

FIGS. 4 and 5 are flowcharts for explaining the operation of benefit conversion and sales promotion circulation in the sales promotion circulation method.

Hereinafter, the steps will be described in order of the step numbers illustrated in FIGS. 4 and 5.

Step S201: The user (customer) redeems the benefit data as a part or all of the payment at the store (business operator) providing the benefit service. Then, a notification of benefit use (user ID, payee ID, and the like) is transmitted from the benefit payee system 200β of the business operator to the sales promotion circulation system 100. Here, the payee ID is ID information unique to the business operator of the payee of the benefit data. The benefit conversion unit 120 receives the notification of benefit use.

Step S202: The benefit conversion unit 120 inquires of the user database 141 about the user ID, and acquires information on the benefit quantity that can be redeemed toward a payment to the payee by excluding the amount of the unique benefit data that cannot be used for the payee ID from the benefit quantity owned by the user.

Step S203: The benefit conversion unit 120 notifies the benefit payee system 200β of the benefit quantity that can be redeemed. The benefit payee system 200β determines the benefit quantity to be redeemed toward the payment and notifies the determined benefit quantity to the benefit conversion unit 120.

Step S204: The ownership ratio distribution unit 131a classifies the benefit quantity of the benefit data owned by the user at the current time (excluding the unique benefit data that cannot be used for the payee) for each issuer, and obtains, for each issuer, the issuer's share of the benefit quantity owned by the user as the ownership ratio.

Step S205: The redemption ratio distribution unit 131b determines the allocation of the benefit quantity to be redeemed toward the current payment for each issuer from the benefit data (excluding the unique benefit data that cannot be used for the payee) owned by the user at the current time.

For example, this allocation is performed by allocating the “benefit quantity for each issuer” classified in step S204 according to a predetermined allocation method. For example, the predetermined allocation method may be Proportional allocation, d'hondt method, Saint-Laguerre method, Maximum surplus method, Highest average method, Hare method, Droop method, Hagen-Bishop method, or the like.

Furthermore, for example, the redemption ratio distribution unit 131b may perform adjustment such as increasing the allocation of the benefit quantity to be allocated toward a payment as the issuer has a larger issuance record of the benefit data. Such adjustment makes it possible to promote consumption of benefit data at an issuer having a large issuance record.

The redemption ratio distribution unit 131b obtains, as the redemption ratio, the proportion of the “benefit quantity for each issuer” thus allocated to the benefit quantity to be redeemed.

Step S206: The benefit conversion unit 120 subtracts the benefit quantity redeemed toward the payment from the benefit quantity owned by the user in the user database 141 for each issuer.

Step S207: The benefit conversion unit 120 subtracts a converted amount corresponding to the benefit quantity redeemed toward the payment from the amount of redemption reserve in the conversion database 144 for each issuer.

Step S208: The benefit conversion unit 120 electronically supplements the benefit payee system 200β with the amount of redemption reserve corresponding to the benefit quantity redeemed toward the payment to as a converted amount, thereby completing the conversion of the benefit data.

Step S211: The exception processing unit 133 refers to the history database 142 with the user ID, and searches for a history (self-sales promotion history) over a predetermined time period of the user's ownership of the benefit data issued by the payee. The exception processing unit 133 estimates whether or not the user can be said to be a self-sales promotion customer of the payee based on this self-sales promotion history. For example, the predetermined period is set to a purchase interval that enables statistically estimating whether the user is a self-sales promotion customer of the payee according to the type of occupation of the payee of the benefit data, the purchased items and size of payment at the payee, and the like.

Step S212: When it is estimated that the user is not a self-sales promotion customer, the exception processing unit 133 proceeds to step S213.

On the other hand, when the user is determined to be a self-sales promotion customer, it is determined that the user himself/herself has decided to purchase at the payee. Therefore, it is difficult to say that the issuance of the benefit of another business operator has contributed to the sales promotion for the payee. Therefore, the exception processing unit 133 does not perform (exception processing) the sales promotion reward reception processing and transfer processing, and completes the operation for conversion.

Step S213: The reward circulation unit 130 calculates a sales promotion reward for the benefit data according to the payment amount of the user or the like. Here, the sales promotion reward is a kind of success reward that recognizes the sales promotion achieved by the system for mutual use of benefit data. As an example, the sales promotion reward is calculated based on a standard sales increase before and after introduction of the system for mutual use of benefit data. Furthermore, the sales promotion reward may be set to be changed according to the user's payment amount or purchased items. Furthermore, the sales promotion reward may be set to be changed according to a temporal factor such as a campaign or a change in sales. This sales promotion reward is an expense for sales promotion from the perspective of a business operator, and corresponds to a consultant fee for increasing sales or maintaining sales.

Step S214: The reward circulation unit 130 performs reception processing of electronically receiving the calculated sales promotion reward as a consultant fee from the benefit payee system 200β. The reward circulation unit 130 records this reception processing in the sales promotion reward database 143.

Step S215: The reward circulation unit 130 calculates a system cost in the sales promotion reward. The system cost is a cost required to permanently operate the sales promotion circulation system 100, and includes an operating cost of the system, a labor cost, profit, and the like. The reward circulation unit 130 determines an amount obtained by subtracting the system cost from the success reward as the fee to be provided to the issuer of the benefit data. This fee is a circular success reward for recognizing the contribution of the issued benefit data to the sales promotion for the other business operators, and enhances business fairness. Note that, in a case where the system expense is separately collected, the whole sales promotion reward may be set as the fee.

Step S216: The reward circulation unit 130 selectively uses either the ownership ratio distribution unit 131a or the redemption ratio distribution unit 131b based on pre-setting of the sales promotion circulation system 100 or the like. In a case where the ownership ratio distribution unit 131a is selected, the reward circulation unit 130 proceeds to step S217. In a case where the redemption ratio distribution unit 131b is selected, the reward circulation unit 130 proceeds to step S218.

Step S217: The ownership ratio distribution unit 131a distributes the benefit for each issuer according to the ownership ratio, and electronically pays each issuer (benefit issuer system 200α) as a circular success reward for sales promotion. After this processing, the ownership ratio distribution unit 131a proceeds to step S219.

Step S218: The redemption ratio distribution unit 131b distributes the benefit for each issuer according to the redemption ratio, and electronically pays each issuer (benefit issuer system 200α) as a circular success reward for sales promotion. After this processing, the redemption ratio distribution unit 131b proceeds to step S219.

Step S219: The reward circulation unit 130 records distribution statement of the sales promotion rewards in the sales promotion reward database 143.

With the series of operations described above, the operation of benefit conversion and the reward circulation in the sales promotion circulation method is completed.

### <<Effects of Example 1>>

Effects obtained by Example 1 will be described.
(1) As described in the prior art (Patent Literature 1), when the benefit data can be mutually used across different business operators, the convenience of the user is enhanced, but there is a problem that revenue is reduced because each business operator cannot bind the customers to it. Furthermore, in a case where the benefit data issued by a business operator is used for another business operator, the burden of the benefit issuance is paid for the sales promotion of the other business operator, which causes a problem of impairing business fairness.

Therefore, in Example 1, when the user uses the benefit data, the contribution in sales promotion is returned as a sales promotion reward from the payee of the benefit data to the issuer of the benefit data, so that the sales promotion reward is continuously circulated among the business operators as a whole. As a result, in Example 1, a mechanism is technically realized that maintains fairness by enhancing a revenue balance between the business operators by circulation of sales promotion rewards while enhancing user convenience by mutual use of benefit data.

Note that, while the converted amount of the benefit data corresponds to the benefit quantity, the sales promotion reward is an amount according to the payment amount of the user, the profit amount of the business operator, the item purchased, and the like, and therefore they have different amounts. As a result, there is a case where the burden of a small converted amount of benefit data leads to a greater amount of sales promotion reward. Therefore, Example 1 excels in that the sales promotion reward circulates according to the degree of sales promotion success at the payee of the benefit data on a scale different from the amount of burden of the conversion of the benefit data.
(2) In Example 1, an ownership history of benefit data is managed for each user, and it is estimated whether or not the user is a self-sales promotion customer for the current payee based on the ownership history. When the user is estimated to be a self-sales promotion customer of the payee, it is difficult to say that the issuance of the benefit by another business operator contributed to the sales promotion for the payee. Accordingly, when it is estimated that the user is a self-sales promotion customer, Example 1 makes an exception and does not perform reception processing and transfer processing of sales promotion rewards. Therefore, in Example 1, a mechanism for fairly circulating sales promotion rewards is technically realized by excluding, as an exception, self-sales promotion customers whose benefit data from other business operators does not substantially contribute to sales promotion.
(3) In Example 1, the ownership ratio of the benefit quantity owned by the user is obtained for each issuer, and the sales promotion reward fees are distributed to the issuers according to the ownership ratio. Therefore, a business operator who has issued a larger amount of benefit data to the user is recognized as having contributed to sales promotion for other business operators, and a larger sales promotion reward is distributed. As a result, in Example 1, a mechanism for fairly circulating sales promotion rewards is technically realized.
(4) Note that there is a case where unique benefit data owned by the user cannot be used for the payee business operator. In that case, the unique benefit data substantially does not contribute to sales promotion at the payee. Therefore, in Example 1, the ownership ratio of the benefit data owned by the user is obtained excluding the unique benefit data that cannot be used. By distributing the sales promotion rewards to the business operators according to the ownership ratio, in Example 1, a mechanism for fairly circulating the sales promotion rewards is technically realized.
(5) Furthermore, in Example 1, the redemption ratio of the benefit quantity to be redeemed toward the conversion of the benefit data of the user is obtained for each issuer, and the sales promotion reward fees are distributed to the issuers according to the redemption ratio. Therefore, a business operator whose benefit has been redeemed a lot toward benefit conversion for other business operators is recognized as having contributed to sales promotion for other business operators, and a larger sales promotion reward is distributed. As a result, in Example 1, a mechanism for fairly circulating sales promotion rewards is technically realized.

### Example 2

Next, in Example 2, user authentication related to the sales promotion circulation method will be described.

### <<Overall Configuration of Example 2>>

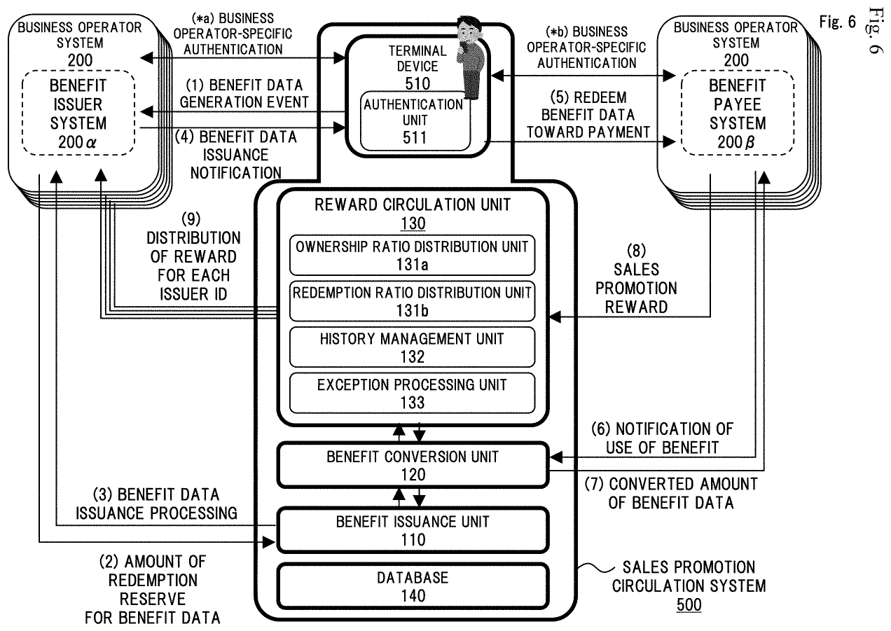

FIG. 6 is a block diagram illustrating an overall configuration of Example 2.

In FIG. 6, a configurational characteristic of Example 2 is that a sales promotion circulation system 500 uses an authentication unit 511 in a terminal device 510 (a mobile terminal, a tablet, a personal computer, or the like) owned by the user.

Since the other components are the same components as those of Example 1, they will not be described again here.

Note that the function of the authentication unit 511 may be realized by executing an application (part of a sales promotion circulation program stored in a computer readable medium) for processing benefit data by the terminal device 510 (computer system).

Furthermore, in a case where the authentication function corresponding to the authentication unit 511 is provided in advance in the terminal device 510 (terminal itself, browser application, or the like), the sales promotion circulation system 500 may use the authentication function of the terminal device 510 as it is as the authentication unit 511 described here.

### <<Operational Characteristics of Example 2>>

The authentication unit 511 acquires authentication information the user has used to log in to the business operator system 200 after confirming the user's permission.

For example, the authentication information acquired from the user includes the following data items.
Identification information for each business operator (business operator ID, connection URL, connection domain, etc.)
User ID used by the user for login for each business operator (or shared ID)
Password used by the user for login for each business operator (or a common password)
Others

The authentication unit 511 encrypts the acquired authentication information, classifies the authentication information for each business operator, and stores and manages the authentication information in a memory in each terminal device 510, a user-specific area on a cloud server, or the like.

When the login screen of the business operator system 200 is detected in the terminal device 510, the authentication unit 511 starts the following authentication operation.
[1] The authentication unit 511 detects the identification information of the business operator from the information of the login screen.
[2] The authentication unit 511 retrieves the authentication information under management with the identification information of the business operator, and determines the user ID and the password to be used for authentication for the corresponding business operator system 200.
[3] The authentication unit 511 automatically inputs the determined user ID and password on the login screen to assist the login operation by the user (or automatically logs in).

The benefit issuance unit 110 performs issuance processing of issuing, via the business operator system 200 (benefit issuer system 200α), benefit data to the terminal device 510 that has been logged in by the authentication unit 511.

The benefit conversion unit 120 performs conversion processing on the business operator system 200 (benefit payee system 200β) that has been logged in by the authentication unit 511. The conversion processing is related to the benefit quantity redeemed toward a payment via the terminal device 510.

The reward circulation unit 130 performs sales promotion circulation processing on the business operator system 200 (benefit payee system 200β) that has been logged in by the authentication unit 511.

Note that since the other operations are those of Example 1, they will not be described again here.

### <<Effects of Example 2>>

Example 2 has the following effects in addition to the effects of Example 1 described above.
(1) Even if the benefit data can be shared among a plurality of business operators, it is assumed that it is necessary to log in to each of the business operator systems 200 when using the benefit. In that case, there is a problem that the convenience of the sharable benefit data is impaired by the need to perform a login operation for each business operator.

To address this issue, in Example 2, the authentication unit 511 (or the authentication function of the terminal device 510) assists the login operation (or automatically logs in) for each business operator (or a shared login operation). Therefore, Example 2 excels in that the need to perform a login operation for each business operator is reduced and the user convenience of the sharable benefit data is improved.

### Example 3

Next, in Example 3, a countermeasure operation in a case where benefit data is left unused will be described.

### <<Overall Configuration of Example 3>>

Since the overall configuration of Example 3 is the same as that of Example 1 or 2, it will not be described again here.

### <<Refund Processing for Retained Benefit Data>>

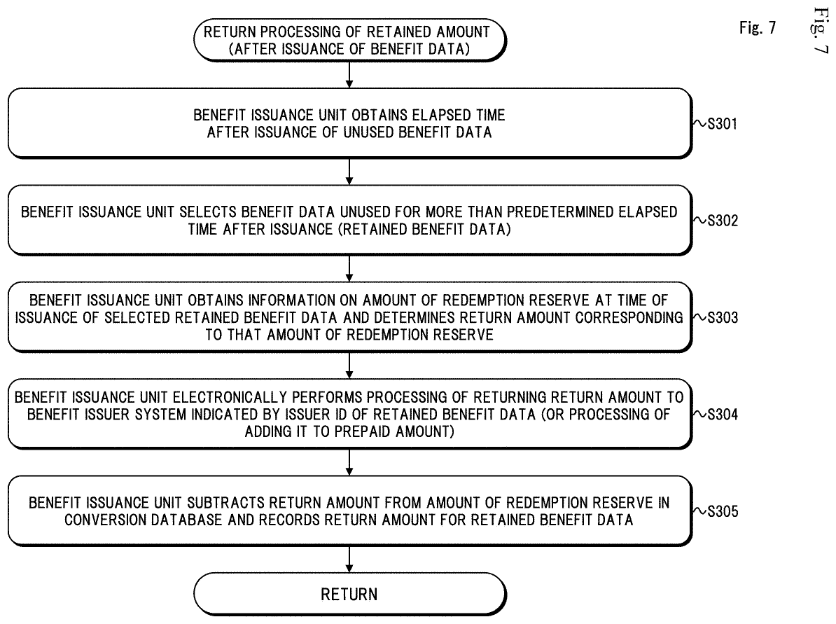

FIG. 7 is a flowchart illustrating an operation of the benefit issuance unit 110 in Example 3.

Hereinafter, the steps will be described in order of the step numbers illustrated in FIG. 7.

Step S301: The benefit issuance unit 110 inquires of the user database 141 and calculates the elapsed time for unused benefit data from the benefit issuance date to the current time.

Step S302: The benefit issuance unit 110 selects benefit data (hereinafter referred to as “retained benefit data”) that has been unused for more than a “predetermined elapsed time” after issuance based on the calculated elapsed time. Here, the “predetermined elapsed time” is a threshold for estimating that the benefit data is unlikely to be used in the future, and may be determined from statistical data regarding a use period of the benefit data, estimation by machine learning, or the like.

Step S303: The benefit issuance unit 110 inquires of the conversion database 144 to acquire information on an amount of redemption reserve corresponding to the selected retained benefit data. Based on the amount of redemption reserve for the retained benefit data, the benefit issuance unit 110 determines a return amount to be temporarily returned to the issuer. For example, the benefit issuance unit 110 may determine the amount of redemption reserve itself to be the return amount. In addition, the benefit issuance unit 110 may determine the return amount by subtracting a fee necessary for operating the system from the amount of redemption reserve. Further, the benefit issuance unit 110 may determine the return amount by increasing the amount of redemption reserve by a merit reward to the issuer for the sales promotion of benefit data.

Step S304: The benefit issuance unit 110 electronically performs processing of returning the determined return amount to the benefit issuer system 200α indicated by the issuer ID of the retained benefit data. Note that, in a case where the issuer has performed the prepayment processing, the benefit issuance unit 110 may return a return amount by adding the return amount to the prepaid amount with respect to the conversion database 144.

Step S305: The benefit issuance unit 110 updates the conversion database 144 so as to subtract the return amount from the amount of redemption reserve.

Furthermore, the benefit issuance unit 110 performs processing of recording the “return amount”, “returned flag information”, and the like of the retained benefit data in the conversion database 144.

Through the above series of operations, the refund processing for the issuer is completed for the retained benefit data that is less likely to be used in the future.

<<Conversion Processing when Retained Benefit Data is Used Thereafter>>

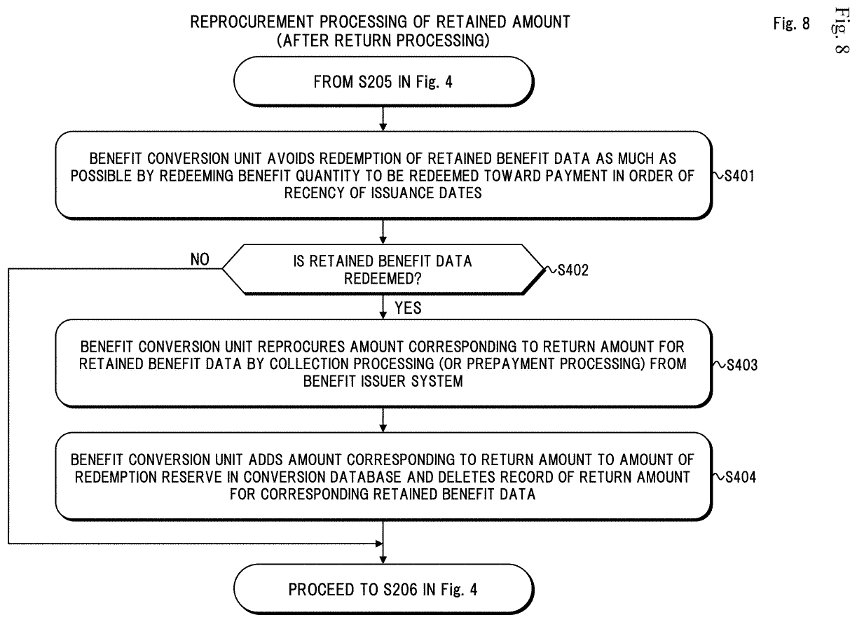

FIG. 8 is a flowchart illustrating an operation of the benefit conversion unit 120 in Example 3.

The processing of steps S401 to S404 illustrated in FIG. 8 is executed by being inserted between steps S205 and S206 of FIG. 4.

Hereinafter, the steps will be described in order of the step numbers illustrated in FIG. 8.

Step S401: Benefit data available to the user may include retained benefit data. Therefore, the benefit conversion unit 120 inquires the user database 141 and redeems the benefit quantity toward a payment in the order of the recency of benefit issue dates. With this redemption rule, the redemption of retained benefit data (or benefit data with an old issue date and thus can become retained benefit data.) is avoided as much as possible.

Step S402: The benefit conversion unit 120 determines whether retained benefit data is included in the benefit data to be redeemed toward the payment. In a case where there is redemption of retained benefit data, the benefit conversion unit 120 proceeds to step S403. On the other hand, when there is no redemption of retained benefit data, the benefit conversion unit 120 proceeds to step S206 in FIG. 4.

Step S403: The benefit conversion unit 120 reprocures an amount corresponding to the return amount for the retained benefit data by collecting it from the benefit issuer system 200α. Note that, in a case where the issuer has performed the prepayment processing, the benefit conversion unit 120 may reprocure the return amount by receiving the return amount from the prepaid amount with respect the conversion database 144.

Step S404: The benefit conversion unit 120 performs, on the conversion database 144, data processing of adding an amount corresponding to the return amount (an amount that was actually able to be reprocured) to the corresponding amount of redemption reserve. Furthermore, the benefit conversion unit 120 deletes the data of the corresponding retained benefit data from the conversion database 144 because the data has been reprocured. After this processing, the benefit conversion unit 120 proceeds to step S206 in FIG. 4.

Through the above series of operations, when retained benefit data is used, the process of returning the corresponding return amount to the amount of redemption reserve is automatically performed.

### <<Effects of Example 3>>

Example 3 has the following effects in addition to the effects of Examples 1 and 2 described above.
(1) In general, there is a case where the issued benefit data is left untouched for a long period of time and consequently will not be used. In such a case, if the amount of redemption reserve from a business operator is kept, this will be an unnecessary expense for the business operator.

To address this issue, in Example 3, refund processing is carried out for the issuer for retained benefit data that has exceeded a predetermined elapsed time and is unlikely to be used in the future. Therefore, Example 3 excels in that unnecessary expenses on the business operator side can be technically reduced by the refund processing of retained benefit data.
(2) In Example 3, when the user redeems refunded reserved benefit data toward a payment, the corresponding return amount of the retained benefit data is reprocured by the collection processing or prepayment processing. Therefore, Example 3 excels in that refunded retained benefit data can be redeemed toward payment processing as with normal benefit data.
(3) In particular, in Example 3, benefit data with a newer benefit issue date is preferentially redeemed toward a payment. With this redemption rule, it is possible to avoid use of retained benefit data and benefit data with an older issue date that may become retained benefit data as much as possible so that they remain. Therefore, Example 3 excels in two ways: it technically protects the interest of a business operator by performing the refund processing while allowing retained benefit data to remain as much as possible, and technically reduces processing required to reprocure the return amount.

### <<Other Supplementary Matters>>

Note that, in the above-described embodiments, the case where the balance processing of the amount of redemption reserve, the converted amount, and the sales promotion rewards, and the like is sequentially performed has been described. However, the present invention is not limited thereto. For example, the number of times of the balance processing may be reduced by performing balance processing by offsetting plus and minus at predetermined intervals (every day, every month, every period, every year, etc.).

Furthermore, in the above-described embodiments, balance processing is carried out by electronic exchange of certain amounts of money. However, the present invention is not limited thereto. For example, the amount of redemption reserve, the converted amount, the prepaid amount, the sales promotion rewards, and the like may be exchanged by exchanging benefit quantity. In that case, a business operator can directly use the benefit quantity received as a sales promotion reward or the like for issuance of benefit data. As a result, distribution of benefit data is promoted.

Furthermore, in the above-described embodiments, in order to simplify the description, the benefit data issuance processing (see FIG. 3) and the benefit data conversion processing (FIGS. 4 and 5) have been separately described. However, the present invention is not limited thereto. For example, if a payment cannot be fully settled due to a shortage of benefit data, benefit data is generated for the portion of the payment. At this time, the conversion processing of the benefit data and the issuance processing of the benefit data are simultaneously executed.

Furthermore, in the above-described embodiments, whether or not the user is a self-sales promotion customer of the payee is estimated based on whether or not the user who has used the benefit data has owned benefit data issued by the payee a predetermined period ago. However, the present invention is not limited thereto.

For example, without setting a predetermined period, whether or not the user who has used the benefit data is a self-sales promotion customer may be simply estimated based on whether or not the user has owned benefit data issued by the payee in the past. According to this straightforward estimation, when there is even a little possibility of the user being a self-sales promotion customer, the user is always estimated to be a self-sales promotion customer, which eliminates ambiguity in the processing of estimating whether or not the user is a self-sales promotion customer.

In addition, for example, a self-sales promotion history that show a history of the user's ownership of benefit data issued by the payee is obtained as a chronological history pattern. Machine learning of a learning model is performed using the history pattern and teacher values as to whether or not the customer is a self-sales promotion customer as learning data, thereby creating an estimator as to whether or not the customer is a self-sales promotion customer. Whether or not the user is a self-sales promotion customer of the payee may be estimated by inputting a “history pattern of the user's ownership of benefit data issued by the payee” to the estimator.

Furthermore, in the above-described embodiments, points and coupons have been described as examples of benefit data. However, the present invention is not limited thereto. The benefit data may be any data of a service that can be redeemed toward a payment made by the user.

Note that the present invention is not limited to the contents of the above-described embodiments, and various modifications can be made.

For example, the above-described embodiments have been described in detail in order to describe the present invention in an easily understandable manner, and the present invention is not necessarily limited to one including all the components or all the steps described above.

In addition, individual elements of the embodiments may be appropriately combined. Furthermore, it is also possible to add, delete, and replace other components or other steps with respect to the embodiment.

### REFERENCE SIGNS LIST

100 Sales promotion circulation system
110 Benefit issuance unit
120 Benefit conversion unit
130 Reward circulation unit
131a Ownership ratio distribution unit
131b Redemption ratio distribution unit
132 History management unit
133 Exception processing unit
140 Database
141 User database
142 History database
143 Sales promotion reward database
144 Conversion database
200 Business operator system
200α Benefit issuer system
200β Benefit payee system
500 Sales promotion circulation system
510 Terminal device
511 Authentication unit

1. A sales promotion circulation method implemented by a computer system, the sales promotion circulation method comprising:
a benefit issuing step of performing issuance processing of issuing, to a user, benefit data whose “benefit quantity that can be redeemed toward a payment made by the user” and “issuer ID unique to an issuer of the benefit quantity” are managed;
a benefit conversion step of performing, for use of the benefit data by the user, conversion processing related to the redeemed benefit quantity between a payee of the benefit data and the issuer indicated by the issuer ID of the benefit data; and
a reward circulation step of performing reception processing of receiving a success reward for sales promotion (hereinafter referred to as “sales promotion reward”) by the benefit data from the payee of the benefit data, and performing transfer processing of providing either a part or all of the sales promotion reward to the issuer indicated by the issuer ID of the used benefit data.

2. The sales promotion circulation method according to claim 1, wherein
the benefit issuing step issues the benefit data as a point returned by the issuer according to a payment made by the user.

3. The sales promotion circulation method according to claim 1, wherein
the benefit issuing step issues the benefit data as a free coupon provided to the user by the issuer.

4. The sales promotion circulation method according to claim 1, wherein
the reward circulation step includes:
a history management step of managing an ownership history of the benefit data for each user; and
an exception processing step of obtaining, based on the ownership history, a self-sales promotion history that is a history of ownership of the user of the benefit data issued by the issuer, estimating whether or not the user is a self-sales promotion customer of the payee based on the self-sales promotion history, and performing exception processing of not performing the reception processing and the transfer processing of the sales promotion reward when the user is estimated to be a self-sales promotion customer.

5. The sales promotion circulation method according to claim 1, wherein
the reward circulation step includes:
an ownership ratio distribution step of obtaining, when the user uses the benefit data, an ownership ratio of the benefit quantity owned by the user for each issuer, distributing a fee for the sales promotion reward to the issuer at the ownership ratio, and performing the transfer processing.

6. The sales promotion circulation method according to claim 5, wherein
the benefit issuing step is capable of performing processing of issuing the benefit data whose allowed range of payees is specified (hereinafter referred to as “unique benefit data”), and
the ownership ratio distribution step excludes the unique benefit data that cannot be used at the payee from calculation of the ownership ratio when obtaining the ownership ratio for each issuer.

7. The sales promotion circulation method according to claim 1, wherein
the reward circulation step includes:
a redemption ratio distribution step of obtaining a redemption ratio of the benefit quantity to be redeemed to convert the benefit data for each issuer, distributing a fee for the sales promotion reward to the issuer at the redemption ratio, and performing the transfer processing.

8. The sales promotion circulation method according to claim 1, wherein
the benefit issuing step receives and holds an amount of redemption reserve corresponding to the benefit quantity from a business operator system of the issuer, and
the benefit conversion step supplements the business operator system of the payee with an amount corresponding to the benefit quantity redeemed toward a payment using the held amount of redemption reserve from the business operator system indicated by the issuer ID.

9. The sales promotion circulation method according to claim 8, wherein
the benefit issuing step includes performing return processing of selecting unused benefit data (hereinafter referred to as “retained benefit data”) after a predetermined elapsed time and returning a return amount corresponding to the amount of redemption reserve for the retained benefit data to the business operator system indicated by the issuer ID, and
when the retained benefit data is used for payment processing after the return processing, the benefit conversion step performs processing of restoring the amount of redemption reserve by reprocuring an amount corresponding to the return amount of the retained benefit data by either collection processing or prepayment processing from the business operator system indicated by the issuer ID.

10. The sales promotion circulation method according to claim 1, further comprising
an authentication step of managing authentication information for logging in to a business operator system in a terminal device of the user, and performing login using the authentication information,
wherein the benefit issuing step performs issuance processing of issuing the benefit data to the “terminal device of the user” that has logged in by the authentication step,
the benefit conversion step performs conversion processing related to the redeemed benefit quantity on the “business operator system” that has been logged in by the authentication step, and
the reward circulation step performs sales promotion circulation processing on the “business operator system” that has been logged in by the authentication step.

11. A sales promotion circulation program stored in a machine-readable storage medium, the sales promotion circulation program causing a computer system to execute the sales promotion circulation method (the benefit issuing step, the benefit conversion step, and the reward circulation step) according to claim 1.

12. A sales promotion circulation system comprising:
a benefit issuance unit configured to perform issuance processing of issuing, to a user, benefit data whose “benefit quantity that can be redeemed toward a payment made by the user” and “issuer ID unique to an issuer of the benefit quantity” are managed;
a benefit conversion unit configured to perform, for use of the benefit data by the user, conversion processing related to the redeemed benefit quantity between a payee of the benefit data and the issuer indicated by the issuer ID of the benefit data; and
a reward circulation unit configured to perform reception processing of receiving a success reward for sales promotion (hereinafter referred to as “sales promotion reward”) by the benefit data from the payee of the benefit data, and performing transfer processing of providing either a part or all of the sales promotion reward to the issuer indicated by the issuer ID of the used benefit data.
